(19) United States
(12) Patent Application Publication
(10) Pub. No.: US 2020/0316925 A1
(43) Pub. Date: Oct. 8, 2020

(54) CURABLE LINERS FOR THE REHABILITATION OF FLUID-CONDUCTING SYSTEMS

(71) Applicant: SML VERWALTUNGS GMBH, Rohrbach (DE)

(72) Inventor: Stefan Reichel, Bad Dürkheim (DE)

(21) Appl. No.: 16/303,928

(22) PCT Filed: May 24, 2017
(86) PCT No.: PCT/DE2017/100443

§ 371 Date: Nov. 21, 2018

(30) Foreign Application Priority Data
May 27, 2016 (DE) 10 2016 109 843.4

(51) Int. Cl. B32B 27/12; B32B 1/08; B32B 5/02; B32B 5/24; B32B 17/02; B32B 19/02; B32B 19/04; B32B 27/06; B32B 27/26; B32B 27/28; F16L 55/165

(52) U.S. Cl. CPC B32B 27/12; B32B 2597/00; B32B 5/022; B32B 5/24; B32B 17/02; B32B 19/02; B32B 19/045; B32B 27/06; B32B 27/26; B32B 27/28; F16L 55/1656; B32B 2262/101; B32B 2262/0215; B32B 2250/03; B32B 2250/40; B32B 2262/02; B32B 1/08

(57) ABSTRACT

The invention relates to a liner for the rehabilitation of fluid-conducting systems, comprising a) an inner film tube based on a thermoplastic, b) an outer film tube based on a thermoplastic, and arranged between the inner and the outer film tube, c) at least one fibrous tube based on a composite material that consists of (c1) industrially generated inorganic fibers, natural fibers or mineral fibers and (c2) man-made fibers, said fibrous tube being impregnated with a curable resin.

The present invention relates to curable liners for refurbishing fluid-conducting systems, composed of an inner film tube, an outer film tube, and, between them, a fibrous tube impregnated with a curable resin. A further aspect of the present invention relates to the use of the liners of the invention for refurbishing fluid-conducting systems of any kind.

A particularly elegant method for refurbishing fluid-conducting systems, especially conduits and similar pipe systems, is to introduce a flexible fibrous tube impregnated with reactive resin and serving as a liner into the conduit, to inflate it therein, so that it clings closely to the inner wall of the conduit, and thereafter to fully cure the resin.

Liners of this kind are available commercially in a host of different embodiments from various manufacturers, and are described in the literature.

Known under the tradename Nordipipe® are liners having a plurality of resin-impregnated plies, with at least one ply consisting of glass fibers and at least one ply consisting of polyester fibers. Impregnation is done using epoxy resins, and the curing takes place thermally. Liners of this type possess limited stability in storage, and the resin used for impregnation can usually be introduced into the liner only immediately before the liner is introduced into the piping system for refurbishment; this entails a series of problems. Uniform impregnation of the inner plies of such a liner is difficult to accomplish, with detrimental consequences for the quality of the installed, cured liner product.

Generally speaking, such systems cannot be cured photochemically, because the inner film must be selected so as to be relatively thick, for reasons of stability, and this is detrimental to the transparency and hence to the photochemical curing. In such systems, the inner film remains as a protective layer for the liner in the piping system.

Under the line Tec® hybrid designation, liners are available which as their supporting structure have a combination of glass fibers and a needlefelt. In terms of their construction, they resemble the products described above, and therefore have the same disadvantages.

The problem addressed by the present invention, therefore, is that of providing photochemically curable liners for refurbishing fluid-conducting systems, without the disadvantages outlined above.

This problem has been solved in accordance with the invention by means of liners for refurbishing fluid-conducting systems, having

a) an inner film tube based on a thermoplastic polymer,
b) an outer film tube based on a thermoplastic polymer, and
c) at least one fibrous tube, impregnated with a curable resin, between inner and outer film tubes, based on a composite material composed of (c1) industrially generated inorganic fibers, natural fibers or mineral fibers, and (c2) manmade fibers.

A fluid, generally speaking, is a medium which presents no resistance to a slow shearing, however slow that shearing may be. The overarching term “fluid” denotes gases and liquids, since most of the laws of physics apply equally to both aggregate states, and many of the properties differ only in quantity, but not in quality.

Merely stated by way of example here, fluid-conducting piping systems include drinking-water and supply-water lines (piping systems with which water is transported from reservoirs or from the site of generation to the site of use or to interim storage facilities), fluid-conducting lines of any kind in the industrial environment, in factories or production plants, or wastewater systems of any kind (e.g., conduits or wastewater collectors or the like).

The fluid-conducting piping systems may be what are referred to as open line systems or else pressurized line systems, examples being pressurized water lines, gas lines or the like.

An open line (in tunnel form, alternatively, open tunnel or grade tunnel) is a customary term for a pipeline, or a section thereof, in which water or a fluid medium passes in accordance with the law of gravity from a higher starting point to a lower end point, with the flow generally not fully traversing the cross section of the line or section of line, with the consequence that, in contrast to a pressurized pipeline, there usually remains a free liquid surface. The line is therefore not fully occupied by the liquid; instead, there remains an air volume which begins at the upper end of the open line and extends downward to a greater or lesser extent, depending on the pressure and the gas solubility. Because in an open line the fluid medium is conveyed only by the force of gravity, open lines are occasionally also referred to as gravity lines.

Component c) comprises a fibrous tube which is impregnated with a curable resin and is based on a composite material composed of (c1) industrially generated inorganic fibers, natural fibers or mineral fibers and (c2) manmade fibers.

A composite material or simply composite in the sense of the present invention is generally an engineering material which is made up of two or more materials joined to one another, and which has properties different from those of its individual components. Important for the properties of the composite materials are physical properties and component geometry. In particular, size effects often play a part. The connection is made by fusion or by form-fitting, or by a combination of both.

Composite materials are therefore to be distinguished from multi-ply systems made up of different materials which form a plurality of layers, without any need for interpenetration of the individual layers.

Composite materials are mixtures of base materials of a single variety. Mutual dissolution of the individual base materials is absent or is present only superficially. The compounding operation therefore connects at least two materials to one another. The aim of this operation is to ensure intimate connection of the phases in the long term and under load.

The resin-impregnated film tube c) based on composite material may be obtained by the winding of corresponding strips of composite material onto and/or around the inner film tube, with the aid of a winding spindle or other suitable apparatus, or by folding and overlaying of strips of composite material. The overlaying of the strips of composite material likewise produces a tube, where the edges lying on top of one another may optionally be connected to one another by means of suitable connecting methods such as stitching, welding or adhesive bonding.

Corresponding methods for producing such liners are known to the skilled person and are described in the literature, and so there is no need for further details here. The advantages of the invention are not dependent on any particular method for production of the liners of the invention.

The composite material contained in the liners of the invention is constructed of two components c1) and c2).

Component c1) is constructed of industrially generated inorganic fibers, natural fibers or mineral fibers.

Industrially generated inorganic fibers here would include glass fibers, basalt fibers, carbon fibers, metal fibers, ceramic fibers, and nanotube fibers

A glass fiber is a long, thin fiber consisting of glass. With regard to production, thin filaments are drawn from a glass melt. Glass fibers are resistant to ageing and weathering, chemically resistant, and noncombustible, and are presently among the most important construction materials.

Basalt fibers possess properties similar to those of glass fibers. The physical properties and hence the fields of use are similar to those of the glass fibers. Basalt fibers are generally produced from a liquid basalt melt at around 1400° C.

Metal fibers are, in principle, fine wires made of metals such as gold, silver, iron, tungsten, aluminum, copper, lead, and alloys thereof, for example, which are referred to as fibers on account of their textile processing.

Ceramic fibers are fibers of inorganic, nonmetallic material. The ceramic fibers are divided into oxidic and nonoxidic types. Known oxidic ceramic fibers are fibers based on aluminum oxide or silicon dioxide; one known type of nonoxidic ceramic fibers are silicon carbide fibers.

Fibers referred to as natural fibers are all those which come from natural sources, such as plants, animals or minerals, and which can be produced and used directly, without further chemical conversion. Natural fibers are therefore distinguished from manmade fibers, which are produced synthetically.

Only by way of example, natural fibers here would include seed fibers, bast fibers, hard fibers, fibers of wool and fine animal hairs, coarse animal hairs, silk fibers, casein fibers, and protein fibers generally.

Seed fibers is a name for those plant fibers which in contrast to stalk fibers or leaf fibers, are obtained from the seeds of the plants, examples being cotton or kapok.

Bast fibers or sclerenchyma fibers are plant fibers which are present in the form of multicellular fiber bundles in the bast of various species of plants. The best-known bast fiber plants utilized economically are industrial hemp (hemp fiber), flax (flax fiber), stinging nettle, ramie, and also kenaf and jute.

Wool, in accordance with German textile labeling law, is the term for the soft hairs of the pelt (in contrast to the outer hair) of sheep in particular. In the wider sense, the term is also used to refer to the spinnable fine hairs obtained from other mammals (e.g., goats, camelids, and angora rabbits), which are frequently given an animal-specific prefix (e.g., angora wool) or are referred to expressly as “hair” (e.g., camel hair).

Examples of fibers from coarse animal hairs are fibers of horse hair, ox hair, goat's hair, badger hair, hog's hair, or reindeer wool.

Silk is a fine fiber which is obtained from the cocoons of the silkworm, the larvae of the silk moth. It is the only continuous textile fiber occurring in nature, and consists primarily of protein.

Casein fibers equate to wool in terms of their properties, and are produced from casein. For production, casein powder is heated together with other natural ingredients and is passed through a spinneret to form filaments.

Mineral fibers, in general, are classified as fibers without organically bonded carbon. Representatives of this group of fibers are asbestos fibers, erionite fibers, fibrous gypsum, and wollastonite fibers.

Corresponding fibers of component c1) are known per se to the skilled person, are described in the literature, and are available commercially. The skilled person will specifically select suitable products for the particular application, exercising his or her knowledge of the art.

Component c2) of the composite material in the liners of the invention comprises manmade fibers. Manmade fibers are to be understood in the sense of the present invention as synthetically produced fibers based on synthetic polymers.

They include, for example, fibers based on polycondensates such as polyesters (Diolen®, Trevira®), polyamides (trade names Nylon®, Perlon®, Dederon®, Grilon®), of polyimides, polyamidimides, polyphenylene sulfide, and also aramid fibers. Examples of chain polymerization fibers are polyacrylonitrile fibers, PTFE fibers, polyolefin fibers (polyethylene, polypropylene), and PVC fibers. Likewise suitable are fibers based on polylactide, or polyurethane-based fibers.

Corresponding products are known per se to the skilled person and are described in the literature, meaning that there is no need here for detailed information.

In some cases, glass or carbon fibers have proven advantageous as component c1). Preferred fibers c2) are fibers based on polyesters, polyamides or polyolefins, or copolymers thereof.

The proportion of the components c1) and c2) in the composite material is not subject per se to any particular restriction and will be selected by the skilled person to conform to the particular application. Generally speaking, the c1/c2 weight ratio is in the range from 5:95 to 95:5, preferably in the range from 20:80 to 80:20.

Suitable strips of composite material are in principle all of the products known to the skilled person, in the form of woven fabrics, knitted fabrics, laid scrims, mats or nonwovens, which may contain fibers in the form of long, continuous fibers, or short fibers.

Woven fabrics are, in general, sheetlike textile products composed of at least two fiber systems which are crossed at right angles, with the so-called warp running in the lengthwise direction and the so-called weft running perpendicularly to it.

According to one preferred embodiment, the liners of the invention, in radial direction, have at least two different resin-impregnated fiber strips, arranged one above another and composed of a composite material.

Knitted fabrics are, generally speaking, textile products which are produced by loop formation.

Laid fiber scrims are a processing variant of fibers, wherein the fibers, rather than being woven, are instead oriented in parallel or at an angle to one another and fixed optionally by means of a tufting thread or an adhesive. Laid fiber scrims, especially laid fiber scrims with parallel fiber orientation, may have a pronounced anisotropy of the strengths in the direction of orientation and perpendicularly thereto, by virtue of the orientation of the fibers, and this may be of interest for certain applications.

A nonwoven web consists of loosely aggregated fibers which are not connected with one another. The strength of a nonwoven web is based only on the fiber-inherent adhesion, but can be influenced by working up. In order that the nonwoven web may be processed and utilized, it is generally consolidated, for which there are a variety of methods that can be employed.

Nonwovens are different from woven or knitted fabrics, which are distinguished by the laying of the individual fibers or threads in a manner determined by the production process. Nonwovens, by contrast, consist of fibers whose positioning can be described only by the methods of statistics. The fibers in the nonwoven are disposed randomly to each other. The term nonwoven (i.e., not woven) therefore delimits them clearly from woven fabrics. Nonwovens are differentiated by qualities including the fiber material (the polymer in the case of manmade fibers, for example), the bonding process, the type of fiber (staple fiber or continuous-filament fiber), the linear fiber density, and the fiber orientation. The fibers here may be deposited in a defined manner in one preferential direction, or they may be in a state of wholly stochastic orientation, as in the case of the random-laid nonwoven.

If the fibers have no preferential direction in their alignment (orientation), the nonwoven web is said to be isotropic. If the fibers are disposed more frequently in one direction than in another direction, this is called anisotropy.

Also suitable as fiber strips are felts. A felt is a sheetlike structure comprising an unordered fiber material which is difficult to separate. In principle, therefore, felts are not woven textiles. Felts are produced, from manmade fibers and plant fibers, usually by dry needling (needlefelts) or by consolidation with jets of water emerging at high pressure from a nozzle beam. The individual fibers in the felt are interlinked with one another without order.

Needlefelt is produced mechanically in general with numerous needles having barbs, the barbs being in an inverted arrangement as on a harpoon. As a result, the fibers are pressed into the felt and the needle is easily withdrawn. Repeated puncturing causes the fibers to become interlooped with one another, after which they may be aftertreated chemically or with steam.

Like nonwovens, felts can be produced from virtually all natural or synthetic fibers. In addition to or alongside needling, the fibers can also be entangled using a pulsed water jet or a binder. The latter processes are especially suitable for fibers without a scale structure such as polyester fibers or polyamide fibers.

Felts usually have a good temperature stability and are generally moisture-repellent, which may be an advantage particularly in the context of application in liquid-conducting systems.

Through the combined use of a plurality of different fibrous strips differing in their construction in terms of fiber type, fiber length, fiber incorporation, or fiber orientation, it is possible to tailor the profile of properties of the liners of the invention to the particular application, without any need for costly and inconvenient conversion work on the apparatus used for production. Through the choice of the sequence in which the at least two different fiber strips are arranged, it is possible to customize the radial and longitudinal profile of the liners of the invention and adapt them optimally to the specific application.

The length of the fibers used is not per se subject to any particular restriction, meaning that both long fibers and short fibers or fiber fragments can be used. Via the length of the fibers used it is also possible to adjust and control the properties of the corresponding fiber strips over wide ranges.

Suitable methods for producing composite materials from glass fibers and fibers based on thermoplastics or carbon fibers, are known per se to the skilled person and are described in the literature, so rendering a detailed description unnecessary at this point.

According to one embodiment of the invention, there may be one or more further resin-impregnated fiber tubes present besides (in addition to) the resin-impregnated fibrous tube based on a composite material. These tubes may be present in the same form as described above for the fiber composite tube—that is, in the form of woven fabrics, knitted fabrics, laid scrims, mats or nonwovens, containing fibers in the form of long, continuous-filament fibers or short fibers. The statements made above apply correspondingly.

In certain cases it has proven advantageous if the resin-impregnated, composite material-based fibrous tube is selected from woven fabrics, knitted fabrics, laid scrims, mats, felts or nonwovens, where the length of the fibers can be selected according to the desired application. In this case, for example, the resin-impregnated fibrous tube may be a laid fiber scrim formed from continuous-filament fibers oriented in parallel, preferably continuous-filament glass fibers oriented in parallel. The continuous-filament fibers are advantageously oriented substantially perpendicularly to the lengthwise direction of the resin-impregnated fiber tube.

A first fibrous tube of this kind can be combined preferably with a second fibrous tube or a fiber strip in which fibers are present in an undirected arrangement in a random fiber mat. The first fibrous tube gives the liner very good strength in the lengthwise direction, this being an advantage on installation into the piping systems to be refurbished. The second fiber tube, with undirected fibers in the form of a random fiber mat, stabilizes the inner surface, by virtue of the high level of resin uptake, and prevents pores on the inner surface, which on prolonged contact with aggressive media could result in damage. Through the use of the directed laid fiber scrim, moreover, there is a reduced risk of the fiber mat being pulled apart during impregnation, with the consequence of nonuniform impregnation. This embodiment is also preferentially amenable to static requirements which are imposed on the liner.

In the resin-impregnated fibrous tube based on a composite material, the laid fiber scrim may with particular advantage already have been needled or stitched together with a random fiber mat; in other words, the first and also the subsequent fiber tubes that are optionally introduced thereafter may also have a multilayer construction. In some cases it has been found advantageous in this case for at least one of the following fiber strips, arranged on the first fibrous tube based on a composite material, to have a multilayer construction such that, between two layers with undirected fibers, there is an interlayer with chopped fibers disposed parallel to the lengthwise direction of the fiber strip, these fibers preferably having a length in the range from 2 to 200, preferably from 3 to 40 cm.

According to one preferred embodiment, the resin-impregnated fibrous tube based on the composite material c) is obtained by the winding of fiber strips with the aid of an apparatus as described in WO 95/04646.

As component a), the liners of the invention have an inner film tube based on a thermoplastic polymer.

As component b), the liners of the invention have an outer film tube based on a thermoplastic polymer.

The structure and construction of the inner film tube and outer film tube are not subject to any particular restriction in terms of the selection of material.

According to one preferred embodiment, the inner and/or the outer film tube have functional groups which allow attachment to component c).

Film tubes a) and b) having functional groups may be produced in principle in any way known to the skilled person. Thus, for example, it is possible to use prefabricated seamless tubes, or else tubes which are obtained by marrying the lengthwise edges of flat films and carrying out corresponding connection of the mated edges, by means of bonding or welding, for example, or by application of a film strip. Lastly, as a suitable process for producing the outer tube film with functional groups, it is also possible to employ a winding process wherein a film strip is wound as described in WO 95/04646, for example. All of the processes are in principle equally suitable, and the skilled person will select the best-suitable process on the basis of his or her art knowledge, taking account of the prevailing application scenario.

The way in which the functional groups are introduced into the inner and/or outer film tube is not subject per se to any restriction, and it is possible in principle to employ all of the methods known to the skilled person and described in the literature. The only condition is that the functional groups are present on the surface for as long as is needed for reaction with the fibrous tube and preferably with the fiber material, or, more particularly, with the photochemically curable resin. Where the reaction takes place only upon (during) curing (something which has emerged in certain cases as being advantageous), this requires the functional groups to have a corresponding stability, since the liners of the invention are generally preassembled and may spend several weeks or even months between production and full curing in the system that is to be refurbished. An advantage of reaction only on full curing is that during installation and the marrying of the liner to the walls of the system to be refurbished, the expectation is that there will be no interactions or only minimal interactions between the inner and/or outer film and the component c), such interactions possibly having disadvantageous consequences and leading, for example, to creasing or comparable problems.

Suitable functional groups for the inner and/or outer film tube are, for example, carboxylic acid, carboxylic anhydride, carboxylic ester, carboxamide, carboximide, amino, hydroxyl, epoxide, urethane, and oxazoline groups, to name just a few preferred representatives. Particularly preferred are carboxylic acid, carboxylic anhydride or epoxide groups.

They may be obtained by copolymerization of corresponding monomers with other monomers from which the polymers forming the outer film are produced, or else by joint use of polymers without functional groups and polymers with functional groups, and are obtained preferably via the melt or by coextrusion.

For a reaction to take place between the functional groups of the outer film and the resin, the functional groups must be available on the side of the outer film which in the installed state is facing the resin-impregnated fiber tube; that is, they must be present on this surface. Composite films of polyolefins and polyamides in which the side facing the fibrous tube has no functional (carboxamide) groups, as have already been described in the literature for use as inner film in corresponding systems curable photochemically, do not in general meet these conditions.

Suitable reactive monomers for introducing suitable functional groups are, for example, maleic acid, maleic anhydride, itaconic acid, (meth)acrylic acid, and glycidyl(meth)acrylate, and vinyl esters, especially vinyl acetate, vinylphosphonic acid and its esters, and also ethylene oxide and acrylonitrile, to name but a few preferred representatives.

The fraction of the comonomers for introducing the functional groups is in general in the range from 0.1 to 50, preferably from 0.3 to 30, and more preferably from 0.5 to 25 wt %, based on the total weight of the monomer mixture.

These monomers may be copolymerized with the other monomers in accordance with methods that are known per se and are described in the literature, such as in the melt or in solution, for example, or may be reacted with—by being grafted onto, for example—polymers or monomers which do not have functional groups.

In the case of grafting, the monomers in question are reacted with an existing polymer scaffold. Corresponding processes are known to the skilled person and described in the literature, and so there is no need here for further details.

Below, a number of preferred groups of polymers will be described in somewhat more detail, although the invention is not confined to these groups of polymers.

Where a resin curable by irradiation is used in the fiber tube, there is a preference for use of outer films which are impervious to the light used for irradiation. In this way, protection against premature full curing is improved, as may occur if the liners are exposed to light during storage, before installation. Since the irradiation is carried out generally using UV light having wavelengths in the range from 300 to 500 nm, preferably in the range from 350 to 450 nm, the outer film ought to exhibit high absorbance in these wavelength ranges.

For the inner film, in contrast, when using a photochemically curable resin, the desire is for a high perviosity (transmittance) in these wavelength ranges, in other words for low absorbance.

The desired transparency of the inner film is also dependent on its thickness, and there is a preference, in the context of the present invention, for inner film tubes which have a thickness in the range from 40 to 800 μm, preferably from 80 to 250 μm, and more preferably from 100 to 200 μm.

The absorbance of films is characterized in general via the transparency, i.e., the capacity of the film under investigation to let through (transmit) electromagnetic waves of the wavelengths under investigation. Incident photons interact with different constituents of the material according to their energy, and hence the transparency of a material is dependent on the frequency of the electromagnetic wave.

A first group of preferred polymers for inner and outer film tubes are, for example, homopolymers or copolymers of olefins, more particularly of α-olefins having preferably 2 to 8, more particularly 2-6, carbons. Particularly preferred monomers are ethene, propene, and octene, the latter also being readily copolymerizable with ethene.

Comonomers contemplated for the aforementioned olefins include, in particular, alkyl acrylates or alkyl methacrylates which derive from alcohols having 1 to 8 carbons, with ethanol, butanol or ethylhexanol being just some preferred examples. With these it is then possible to copolymerize corresponding reactive comonomers in order to introduce the aforementioned functional groups.

A first preferred group of such polymers having functional groups are copolymers of ethene with ethyl acrylate or butyl acrylate and acrylic acid and/or maleic anhydride. Products of this kind are available, for example, from BASF SE under the trade name Lupolen® KR 1270.

Ethene/propene copolymers with suitable comonomers for incorporating the corresponding functional groups are also suitable.

Mention may further be made of ethene/octene copolymers grafted with corresponding monomers to introduce functional groups. Here, by way of example, mention may be made of Fusabond® NM493 D from DuPont.

In some cases, what are called functionalized EPDM rubbers have proven advantageous, and may bring advantages in terms of the marrying of the liner, by virtue of their elastic qualities. Mention may be made here, by way of example, of terpolymers composed in general of at least 30 wt % of ethene, at least 30 wt % of propene, and a diene component at up to 15 wt % (generally diolefins having at least 5 carbons such as dicyclopentadiene, 1,4-hexadiene, or 5-ethylidenenorbornene). A commercial product that could be mentioned here is Royaltuf® 485 from Crompton.

Suitable polymers, moreover, are those of vinylaromatic monomers and dienes, as for example styrene and dienes, where the dienes may be wholly or partly hydrogenated, and which have corresponding functional groups. Such copolymers may have a random construction or a block structure, with hybrid forms (known as tapered structures) also being possible. Corresponding products are described in the literature and are available commercially from various suppliers. Examples would include the commercial product series Styrolux® and Styroflex® from BASF SE, or specifically, as a styrene/ethene/butene copolymers functionalized with anhydride groups, Kraton® G 1901 FX from Shell.

The polymers of the outer film may also contain the functional groups latently—that is, in a form in which the actual functional group is liberated only in the course of the curing.

It is possible, moreover, to use mixtures of polymers, with only one of the polymers having the functional groups or latent functional groups of the aforementioned kind.

As suitable polymers having functional groups for this variant, for example polyamides, polyoxymethylene, acrylonitrile-butadiene-styrene (ABS) copolymers, polymethyl methacrylate, polyvinyl acetate, and polyvinyl alcohol are suitable.

It is essential here that the polar polymer be readily miscible with the polymer having no functional groups. Mixing may take place advantageously in the melt. The amount of admixed polymer having functional groups is generally in the range from 0.01 to 50 wt %, based on the mixture.

Fundamental suitability, taking account of these criteria, is possessed by polyolefins such as polyethylene or polypropylene, polyamides, polyesters such as polybutylene terephthalate, polyethylene terephthalate or polyethylene naphthalate, polyvinyl chloride, polyacrylonitrile, or else thermoplastic polyurethanes or mixtures of these polymers. Thermoplastic elastomers as well are fundamentally suitable. Thermoplastic elastomers are materials wherein elastic polymer chains are incorporated in thermoplastic material. In spite of the absence of vulcanization, as is required in the case of the conventional elastomers, thermoplastic elastomers have rubber-elastic qualities, which may be an advantage in certain applications. Examples here would include polyolefin elastomers or polyamide elastomers. Such products are described in the literature and are available commercially from a variety of manufacturers, and so there is no need here for detailed information.

Instead of by copolymerization or by mixing or grafting, the functional groups can also be introduced into the outer film by means of suitable adhesion promoters, which are applied to the surface of the films. Suitable adhesion promoters in the case of this embodiment are, for example, silanes, solutions or melts of polar or functionalized polymers, and also suitable adhesives and adhesion promoter films. They are preferably applied in an even (homogenous) covering to the film which forms the inner film tube, so as to obtain a uniform distribution of the functional groups.

Lastly, the aforementioned functional groups may also be obtained by surface treatment of the films that form the outer film tube by means of gases such as oxygen, fluorine or chlorine. The action of these media results in the development at the surface of oxygen-containing functional groups of the preferred kind stated at the outset, such as acid, acid anhydride or epoxide groups. It may be noted at this point, however, that the distribution of the functional groups on the surface is difficult to control, and so the probability of uneven distribution is higher than in accordance with the above-described methods of copolymerization or graft polymerization or the use of adhesion promoters. With this variant, moreover, there may be greater fluctuations in the nature and amount of the functional groups.

Functional groups can also be incorporated by means of plasma or corona treatment. Corresponding processes are known to the skilled person and described in the literature. In some cases, however, it has emerged that in the case of corona treatment there is a decrease in the level of functional groups over time, which may be a disadvantage if the liners of the invention are stored for prolonged periods before being introduced into the fluid-conducting systems under refurbishment.

Generally speaking (and independently of the nature of the polymer), but without being limited to this, the film of which the at least one outer film tube is formed has a thickness in the range from 40 to 2000 μm, preferably in the range from 50 to 1500 μm, and more preferably from 80 to 1000 μm. The thickness of the film strip may also be selected to be greater if a greater strength is desired.

The outer film tube may also have reinforcement, such as lamination with a nonwoven web, for example, as described in EP 1180 225.

If means of reinforcement are to be used, they are generally fiber-based, being based more particularly on fiber strips.

Fiber strips suitable in principle are all of the products known to the skilled person, in the form of woven fabrics, knitted fabrics, laid scrims, mats or nonwovens, which may contain fibers in the form of long, continuous-filament fibers, or short fibers. The thickness of the reinforcement, such as of the nonwovens, for example, is situated advantageously in the range from 0.005 to 2 mm, more preferably in the range from 0.1 to 1 mm.

In accordance with one particularly preferred embodiment, the liners of the invention have a resin-impregnated, composite material-fibrous tube which comprises at least one fiber strip having fibers oriented substantially perpendicularly to the lengthwise direction of the fiber strip, and at least one further fiber strip having fibers oriented parallel to the lengthwise direction of the fiber strip.

Impregnation of the resin-impregnated fiber strips with resin is accomplished in a manner known per se. Corresponding methods are known to the skilled person and described in the literature, and so there is no need here for detailed pronouncements.

The skilled person will select the resin used for impregnation as a function of the nature of the fiber reinforcement and the required properties in the individual application case. Resins for the impregnation of fiber systems are described in large numbers in the literature and known per se to the skilled person.

According to one preferred embodiment, a photochemically curable resin is used.

A preferred group of such photochemically curable resins are unsaturated polyester resins or vinyl ester resins, which may be present in solution in styrene and/or an acrylic ester, for example. Suitable reactive resins of this kind are known to the skilled person and are available commercially in the trade in a variety of forms.

Reactive resins of this kind may be fully cured by means, for example, of electromagnetic radiation, as for example by UV light with photoinitiators as described in EP-A 23634, for example. Also possible are what are called combination cures with an initiator used for thermal curing (a peroxide initiator, for example) in combination with the aforementioned photoinitiators, such systems having proven advantageous particularly where the wall thicknesses of the liners are substantial. One process for such combination curing is described in EP-A 1262708, for example.

After impregnation, the resin may usefully be thickened, as described in WO-A 2006/061129, for example. This results in an increase in the viscosity of the resin and therefore gives the fiber strips used better handling qualities.

The width of the fiber strips for producing the fiber tubes is not subject per se to any particular restrictions; for a multiplicity of applications, fiber strips having a width of 20 to 150, preferably of 30 to 100, and more particularly of 40 to 80 cm have proven suitable.

The thickness of the fiber strips for the fiber tubes in the liners of the invention is likewise not subject to any particular restriction, and is determined by the thickness of the liner for the desired application. Fiber strip thicknesses which have been found appropriate in practice are in the range from 0.01 to 1, more particularly 0.05 to 0.5 mm.

For the actual refurbishment of a conduit, the completed liner, which may have a length of in general 1 to 1000 m, more particularly 30 to 300 m, is introduced into the piping system for refurbishment, where it is inflated using—for example—pressurized water or, preferably, with air, so that it clings closely to the inner wall of the piping system undergoing refurbishment. Lastly, the resin is cured preferably by means of electromagnetic radiation, as described, for example, in EP-A 122 246 and DE-A 198 17 413.

The liners of the invention may be produced, for example, in accordance with the methods described in WO 95/04646, and with the aid of the apparatus described therein; to which reference is hereby made for further details.

The liners of the invention are suitable for refurbishing fluid-conducting systems of any kind, and allow rapid refurbishment with minimization of the downtimes of the piping systems, during which they must be taken out of operation. Standstill times are therefore reduced compared to the replacement of damaged parts. The liners of the invention can be employed with particular advantage for the refurbishment of systems which for conventional repair or refurbishment, with replacement of components, are difficult to access, being constituents of an overall apparatus, for example, or being inaccessible because, for example, they are laid in the earth. Examples here would include piping systems for the transport of water or wastewaters (conduit systems and the like) which are laid in the earth in cities and settlements, frequently under streets or other trafficways. In the case of refurbishment by replacement, these systems must first be exposed by corresponding earthworks, and the trafficways are unavailable for traffic over long periods, leading to considerable adverse effects especially where the incidence of traffic is relatively high. By comparison to this, the refurbishment of such systems using the liners of the invention can be carried out without earthworks, in a few hours or days, without extensive earthworks.

The use of the liners of the invention for refurbishing fluid-conducting piping systems, more particularly water and wastewater piping systems (conduits) or industrial pipeline systems, is therefore a further subject of the invention.

1. A liner for refurbishing fluid-conducting systems, having
a) an inner film tube based on a thermoplastic,
b) an outer film tube based on a thermoplastic polymer, and
c) at least one fibrous tube, impregnated with a curable resin, between inner and outer film tubes, based on a composite material composed of (c1) industrially generated inorganic fibers, natural fibers or mineral fibers, and (c2) manmade fibers.

2. The liner as claimed in claim 1, wherein the industrially generated inorganic fibers are glass fibers and the manmade fibers are fibers based on thermoplastic polymers.

3. The liner as claimed in claim 1, characterized in that the curable resin is photochemically curable.

4. The liner as claimed in claim 1, characterized in that the curable resin is an unsaturated polyester resin or a vinyl ester resin.

5. The liner as claimed in claim 1, characterized in that besides the resin-impregnated fibrous tube based on a composite material there are one or more further resin-impregnated fibrous tubes.

6. The liner as claimed in claim 1, characterized in that the inner and/or outer film tube has functional groups selected from carboxylic acid, carboxylic anhydride, carboxylic ester, carboxamide, carboximide, amino, hydroxyl, epoxide, urethane, and oxazoline groups.

7. The liner as claimed in claim 6, characterized in that the functional groups are carboxylic acid, carboxylic anhydride or epoxide groups.

8. The liner as claimed in claim 1, characterized in that the inner film tube as well, on the surface facing a resin-impregnated fibrous tube in the installed state, has functional groups which enter into a reaction with the fibrous tube.

9. The liner as claimed in claim 1, characterized in that the inner film tube has a thickness in the range from 40 to 800 preferably from 80 to 250 μm.

10. The use of the liners of the invention as claimed in claim 1 for refurbishing fluid-conducting systems.
